(19) United States
(12) Patent Application Publication
(10) Pub. No.: US 2021/0218053 A1
(43) Pub. Date: Jul. 15, 2021

(54) LITHIUM ION BATTERY AND METHOD FOR PREPARING LITHIUM ION BATTERY

(71) Applicant: BOE TECHNOLOGY GROUP CO., LTD., Beijing (CN)

(72) Inventors: Quanguo ZHOU, Beijing (CN); Hao TANG, Beijing (CN); Lijia ZHOU, Beijing (CN); Zhidong WANG, Beijing (CN); Qingguo YANG, Beijing (CN); Yawen ZHU, Beijing (CN); Jiuyang CHENG, Beijing (CN)

(21) Appl. No.: 16/647,693

(22) PCT Filed: Feb. 21, 2019
(86) PCT No.: PCT/CN2019/075718

§ 371 Date: Mar. 16, 2020

(51) Int. Cl. H01M 10/0525; H01M 4/36; H01M 10/0562; H01M 4/583; H01M 10/0565; H01M 10/0566; H01M 4/66; H01M 4/38; H01M 4/48

(52) U.S. Cl. CPC H01M 10/0525; H01M 4/366; H01M 10/0562; H01M 4/583; H01M 10/0565; H01M 2004/028; H01M 4/663; H01M 4/662; H01M 4/382; H01M 4/483; H01M 10/0566

(57) ABSTRACT

A lithium ion battery and a method for preparing a lithium ion battery are disclosed. The lithium ion battery includes: a first electrode current collector, a first electrode layer, an electrolyte layer, a second electrode layer, and a second electrode current collector which are laminated, and further includes a first electron transport layer and/or a second electron transport layer. The first electron transport layer is provided between the first electrode layer and the first electrode current collector, and the second electron transport layer is provided between the second electrode layer and the second electrode current collector.

### TECHNICAL FIELD

Embodiments of the present disclosure relate to a lithium ion battery and a method for preparing a lithium ion battery.

### BACKGROUND

Lithium ion batteries have the characteristics of high energy density, portability, long service life, and the like, and are widely used in electronic devices, electric vehicles and other fields. The lithium ion batteries can be classified as liquid lithium ion batteries, polymer lithium ion batteries, and solid-state lithium ion batteries according to their electrolyte forms. A liquid lithium ion battery uses liquid electrolyte and separate the positive and negative electrodes of the battery by a membrane. A polymer lithium ion battery uses polymer electrolyte. A solid-state lithium ion battery uses solid-state electrolyte, and have higher safety than liquid lithium ion batteries. In addition, solid-state lithium ion batteries further have the advantages of light weight, long service life, fast charging, long battery life, ability to be charged and discharged at a high temperature, flexibility, and the like, can be manufactured on various substrates, and meet the design requirements of various circuits.

### SUMMARY

At least one embodiment of the present disclosure provides a lithium ion battery, which includes: a first electrode current collector, a first electrode layer, an electrolyte layer, a second electrode layer and a second electrode current collector which are laminated, and a first electron transport layer and/or a second electron transport layer. The first electron transport layer is provided between a first electrode layer and a first electrode current collector, and the second electron transport layer is provided between a second electrode layer and a second electrode current collector.

For example, in the lithium ion battery provided by at least one embodiment of the present disclosure, materials of the first electron transport layer and/or the second electron transport layer are inorganic electron transport materials.

For example, in the lithium ion battery provided by at least one embodiment of the present disclosure, the inorganic electron transport materials include fluorides.

For example, in the lithium ion battery provided by at least one embodiment of the present disclosure, the fluorides include one or more of LiF, NaF, CsF, MgF₂, CaF₂ and BaF₂.

For example, in the lithium ion battery provided by at least one embodiment of the present disclosure, a thickness of the first electron transport layer and/or a thickness of the second electron transport layer is from 1 nm to 10 nm.

For example, the lithium ion battery provided by at least one embodiment of the present disclosure further includes: a substrate and a buffer layer provided on the substrate. The first electrode current collector, the first electrode layer, the electrolyte layer, the second electrode layer, and the second electrode current collector which are laminated are provided on the buffer layer.

For example, in the lithium ion battery provided by at least one embodiment of the present disclosure, the first electrode layer is a positive electrode layer, including one or more of LCO, LMO, LNMO, NCA, NCM, CuS₂, TiS₂, FeS₂, SnS₂, LiFePO₄, LiMnPO₄, LiCoPO₄, LiNiPO₄, Li₃V₂(PO₄)₃, Li₂FeSiO₄, Li₂MnSiO₄, Li₂CoSiO₄, Li₂NiSiO₄, Li₂Fe₂(SO₄)₃, LiFeBO₃, LiMnBO₃, LiCoBO₃, LiNiBO₃, and V₂O₅.

For example, in the lithium ion battery provided by at least one embodiment of the present disclosure, materials of the first electrode current collector include one or more of Mo, Al, Ni, stainless steel, graphite and amorphous carbon.

For example, in the lithium ion battery provided by at least one embodiment of the present disclosure, an electrolyte layer includes a solid electrolyte layer or a polymer electrolyte layer, which separates the first electrode layer and the second electrode layer.

For example, in the lithium ion battery provided by at least one embodiment of the present disclosure, materials of a solid state electrolyte layer include one or more of LiPON, LLTO, LGSP, LPS, Thio-LiSiCON, LATP, LLZO, Li₂S, SiS₂, P₂S₅, SiS₂, and B₂S₃.

For example, in the lithium ion battery provided by at least one embodiment of the present disclosure, an electrolyte layer includes a membrane and liquid electrolyte or polymer electrolyte, the membrane is provided between the first electrode layer and the second electrode layer, and the liquid electrolyte or the polymer electrolyte is immersed in the membrane.

For example, in the lithium ion battery provided by at least one embodiment of the present disclosure, the second electrode layer is a negative electrode layer, including one or more of SnO₂, graphite, lithium metal, lithium alloy and lithium compound.

For example, in the lithium ion battery provided by at least one embodiment of the present disclosure, materials of the second electrode current collector include one or more of Mo, Cu, Ni, stainless steel, graphite and amorphous carbon.

At least one embodiment of the present disclosure further provides a method for preparing a lithium ion battery, which includes: forming a first electrode current collector, a first electrode layer, an electrolyte layer, a second electrode layer and a second electrode current collector which are laminated, and forming a first electron transport layer between a first electrode layer and a first electrode current collector, and/or forming a second electron transport layer between a second electrode layer and a second electrode current collector.

For example, in the method for preparing a lithium ion battery provided by at least one embodiment of the present disclosure, forming an electrolyte layer includes forming a solid electrolyte layer or a polymer electrolyte layer so as to separate the first electrode layer and the second electrode layer.

For example, in the method for preparing a lithium ion battery provided by at least one embodiment of the present disclosure, forming an electrolyte layer includes providing a membrane between the first electrode layer and the second electrode layer, and immersing liquid electrolyte or polymer electrolyte into the membrane.

For example, the method for preparing a lithium ion battery provided by at least one embodiment of the present disclosure further includes: providing a substrate; forming a buffer layer on the substrate. The first electrode current collector, the first electrode layer, the electrolyte layer, the second electrode layer, and the second electrode current collector which are laminated are formed on the buffer layer.

For example, in the method for preparing a lithium ion battery provided by at least one embodiment of the present disclosure, forming a first electron transport layer includes forming the first electron transport layer by a thin film forming method using one of the first electrode layer and the first electrode current collector as a substrate.

For example, in the method for preparing a lithium ion battery provided by at least one embodiment of the present disclosure, after the first electron transport layer is formed, the method further includes forming the other of the first electrode layer and the first electrode current collector using the first electron transport layer as a substrate.

For example, in the method for preparing a lithium ion battery provided by at least one embodiment of the present disclosure, forming a second electron transport layer includes forming the second electron transport layer by a thin film forming method using one of the second electrode layer and the second electrode current collector as a substrate.

For example, in the method for preparing a lithium ion battery provided by at least one embodiment of the present disclosure, after the second electron transport layer is formed, the method further includes forming the other of the second electrode layer and the second electrode current collector using the second electron transport layer as a substrate.

In the lithium ion battery provided by at least one embodiment of the present disclosure, the provision of the first electron transport layer and/or the second electron transport layer can improve the charging and discharging efficiency of the lithium ion battery.

### BRIEF DESCRIPTION OF THE DRAWINGS

In order to more clearly illustrate the technical schemes of the embodiments of the present disclosure, the drawings of the embodiments will be briefly described in the following. It is obvious that the described drawings below are only related to some embodiments of the disclosure and are not limitative to the disclosure.

FIG. 1 is a schematic diagram of a lithium ion battery according to an embodiment of the present disclosure;

FIG. 2 is a schematic diagram of a lithium ion battery according to another embodiment of the present disclosure;

FIG. 3A is a schematic diagram of a lithium ion battery in a charging process according to an embodiment of the present disclosure.

FIG. 3B is a schematic diagram of a lithium ion battery in a discharging process according to an embodiment of the present disclosure;

FIGS. 4A-4F are schematic diagrams of a lithium ion battery in a preparing process according to an embodiment of the present disclosure; and

FIGS. 5A-5C are schematic diagrams of a lithium ion battery in a preparing process according to another embodiment of the present disclosure.

### DETAILED DESCRIPTION

In order to make the objects, technical schemes and advantages of the embodiments of the present disclosure more clear, the technical solutions of the embodiments of the present disclosure will be described in a clear and full way in connection with the drawings of the embodiments of the present disclosure. Obviously, the described embodiments are some embodiments of the present disclosure, not all embodiments. Based on the described embodiments of the present disclosure, all other embodiments obtained by those of ordinary skill in the art without the use of inventive faculty are within the scope of the present disclosure.

Unless otherwise defined, all the technical and scientific terms used herein have the same meanings as commonly understood by those of ordinary skill in the art to which the present disclosure belongs. The terms “first,” “second,” etc., which are used in the present disclosure, are not intended to indicate any sequence, amount or importance, but used to distinguish various components. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

At present, a lithium ion battery can be generally applied to different applications, for example, it can be made very thin, so that it can be incorporated into an electronic device for meeting the thin profile requirement of the electronic device. However, because each functional film layer of the lithium ion battery is very thin, if problems such as film layer defects occur in the preparing or using process of these functional films, the battery will fail. In addition, because of the transmission of electrons and lithium ions between the positive electrode and the negative electrode of the battery in the charging and discharging processes of the lithium ion battery, the materials of the positive electrode and the negative electrode are easy to deform, thereby affecting the charging and discharging efficiency and service life of the lithium ion battery.

At least one embodiment of the present disclosure provides a lithium ion battery, which includes: a first electrode current collector, a first electrode layer, an electrolyte layer, a second electrode layer, and a second electrode current collector which are laminated, and a first electron transport layer and/or a second electron transport layer. The first electron transport layer is provided between a first electrode layer and a first electrode current collector, and the second electron transport layer is provided between a second electrode layer and a second electrode current collector.

At least one embodiment of the present disclosure further provides a method for preparing a lithium ion battery, which includes: forming a first electrode current collector, a first electrode layer, an electrolyte layer, a second electrode layer and a second electrode current collector which are laminated, forming a first electron transport layer between a first electrode layer and a first electrode current collector, and/or forming a second electron transport layer between a second electrode layer and a second electrode current collector.

Lithium ion batteries and methods for preparing a lithium ion battery of the present disclosure will be illustrated below by several specific embodiments.

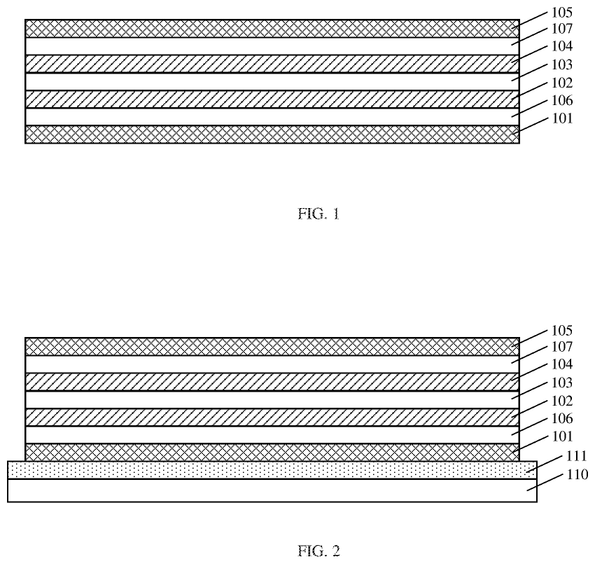

At least one embodiment of the present disclosure provides a lithium ion battery, which is a solid lithium ion battery. As illustrated in FIG. 1, the lithium ion battery includes a first electrode current collector 101, a first electrode layer 102, an electrolyte layer 103, a second electrode layer 104, and a second electrode current collector 105 which are laminated. The lithium ion battery further includes a first electron transport layer 106 and a second electron transport layer 107. The first electron transport layer 106 is provided between the first electrode layer 102 and the first electrode current collector 101, and the second electron transport layer 107 is provided between the second electrode layer 104 and the second electrode current collector 105. For example, the above-described laminated structure may be provided on various appropriate substrates, such as a rigid base plate or a flexible base plate.

Although in the example illustrated in FIG. 1, the lithium ion battery includes both the first electron transport layer 106 and the second electron transport layer 107, in other examples the lithium ion battery may include only one of the first electron transport layer 106 and the second electron transport layer 107, for example, only the first electron transport layer 106 or only the second electron transport layer 107.

In these embodiments, the first electron transport layer 106 can modify an interface between the first electrode layer 102 and the first electrode current collector 101, eliminate or reduce the defects possibly existing in the first electrode layer 102 and the first electrode current collector 101, and enhance the stability of the battery. Also, the first electron transport layer 106 can block ions escaping from the first electrode current collector 101, for example, metal ions diffusing to the first electrode layer 102 and then affecting the performance of the first electrode layer 102. In addition, the first electron transport layer 106 has good electron transport characteristics, which can improve the electron transport capability between the first electrode current collector 101 and the first electrode layer 102, thereby improving the charging and discharging efficiency of the battery.

In these embodiments, the second electron transport layer 107 can modify an interface between the second electrode layer 104 and the second electrode current collector 105, eliminate or reduce the defects possibly existing in the second electrode layer 104 and the second electrode current collector 105, and enhance the stability of the battery. Also, the second electron transport layer 107 can block ions escaping from the second electrode current collector 105, for example, metal ions diffusing to the second electrode layer 104 and then affecting the performance of the second electrode layer 104. In addition, the second electron transport layer 107 has good electron transport characteristics, which can improve the electron transport capability between the second electrode layer 104 and the second electrode current collector 105, thereby improving the charging and discharging efficiency of the battery.

For example, in these embodiments, the first electrode current collector 101 may be a positive electrode current collector layer. In this case, the first electrode layer 102 is a positive electrode layer, and accordingly, the second electrode layer 104 is a negative electrode layer and the second electrode current collector 105 is a negative electrode current collector layer. Alternatively, the first electrode current collector 101 is a negative electrode current collector layer. In this case, the first electrode layer 102 is a negative electrode layer, and accordingly, the second electrode layer 104 is a positive electrode layer and the second electrode current collector 105 is a positive electrode current collector layer. The embodiments do not limit the positions of the positive and negative electrodes of the battery in the laminated structure of the battery.

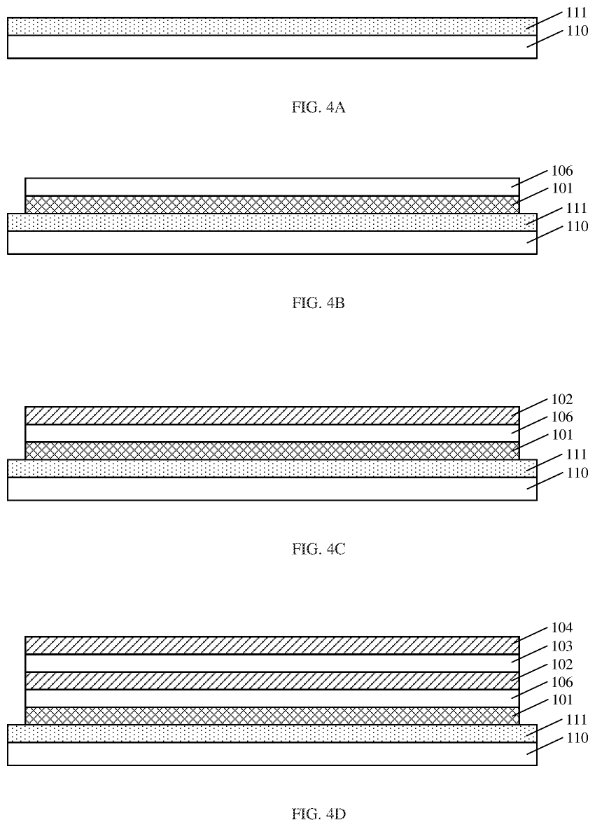

For example, in the case where the first electrode current collector 101 is a positive electrode current collector layer, the first electrode layer 102 is a positive electrode layer, the second electrode layer 104 is a negative electrode layer, and the second electrode current collector 105 is a negative electrode current collector layer, as illustrated in FIG. 3A, in a charging process of the battery, the current from the positive electrode to the negative electrode is formed inside the battery, and electrons move from the negative electrode to the positive electrode accordingly; the first electron transport layer 106 can improve the electron output capability from the positive electrode layer to the positive electrode current collector layer, and the second electron transport layer 107 can improve the electron injection capability from the negative electrode current collector layer to the negative electrode layer. As illustrated in FIG. 3B, in a discharging process of the battery, the current from the negative electrode to the positive electrode is formed inside the battery, and electrons move from the positive electrode to the negative electrode accordingly. The first electron transport layer 106 can improve the electron injection capability from the positive electrode current collector layer to the positive electrode layer, and the second electron transport layer 107 can improve the electron output capability from the negative electrode layer to the negative electrode current collector layer. Therefore, the arrangements of the first electron transport layer 106 and the second electron transport layer 107 can improve the charging and discharging efficiency of the lithium ion battery. For example, in the charging process, the charging amount within unit time may be increased, thus shortening the charging time, and in the discharging process, a larger current may be output within unit time, thereby providing a larger power support.

For example, in these embodiments, the materials of the first electron transport layer 106 and/or the second electron transport layer 107 may be inorganic electron transport materials. The inorganic electron transport materials have good heat resistance. Because phenomena such as heating may occur in the charging and discharging processes of the lithium ion battery, the use of the inorganic electron transport materials can avoid undesirable phenomena caused by heat, such as film layer deformation, material deterioration or the like. In some embodiments, the materials of the first electron transport layer 106 and/or the second electron transport layer 107 may also be organic materials, for example, organic electron transport materials such as polyethyleneimine (PEI), polyacrylamine (PAA), etc.

For example, the inorganic electron transport materials adopted by the first electron transport layer 106 and/or the second electron transport layer 107 include fluorides. For example, the fluorides include one or more of LiF, NaF, CsF, MgF₂, CaF₂ and BaF₂. These fluorides can generate the tunneling effect (which refers to the phenomenon that microscopic particles such as electrons can pass through the barriers that they cannot pass through originally), so they have good electron transport capability, can modify the interface between an adjacent current collector layer and an adjacent electrical active layer, and can have the effect of blocking ion diffusion.

For example, in these embodiments, the thickness of the first electron transport layer 106 and/or the second electron transport layer 107 is from 1 nm to 10 nm, for example, 1 nm, 3 nm, 5 nm, 7 nm, 9 nm, etc. Under this thickness setting, the first electron transport layer 106 and the second electron transport layer 107 can substantially realize their functions without affecting the overall thickness of the battery.

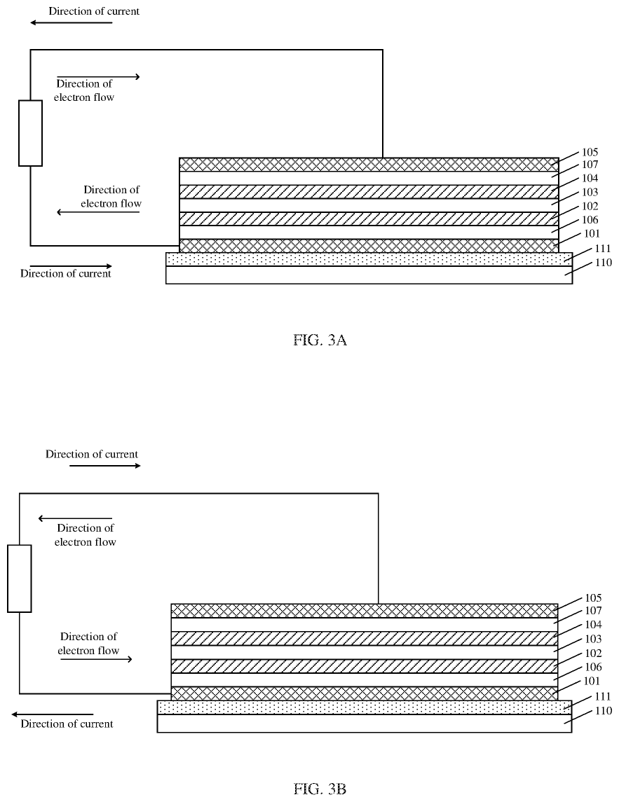

For example, as illustrated in FIG. 2, the lithium ion battery provided in the embodiments may further include a substrate 110 and a buffer layer 111. The buffer layer 111 is provided on the substrate 110, and the first electrode current collector 101, the first electrode layer 102, the electrolyte layer 103, the second electrode layer 104, and the second electrode current collector 105 which are laminated are provided on the buffer layer 111. In these embodiments, the buffer layer 111 can prevent impurities which may exist in the substrate 110 from entering the lithium ion battery and affecting the performance of the battery.

In these embodiments, the substrate 110 may be a rigid substrate or a flexible substrate. For example, the rigid substrate may be a rigid base plate, for which the materials may include glass, polymer (e.g., plastic), metal sheet, silicon wafer, quartz, ceramic, mica, etc. For example, the flexible substrate may be a flexible base plate or a flexible film, for which the materials may include Polyimide (PI), Polyethylene Terephthalate (PET), metal film, etc. For example, the materials of the buffer layer 111 include SiOx, SiNx or Al₂O₃, etc. The materials of the substrate 110 and the buffer layer 111 are not specifically limited in the embodiments.

For example, in these embodiments, the first electrode current collector 101 is a positive electrode current collector layer. The materials of the first electrode current collector 101 include one or more of Mo, Al, Ni, stainless steel, graphite and amorphous carbon. For example, the thickness of the first electrode current collector 101 is from 20 nm to 200 nm, for example, 50 nm, 80 nm, 150 nm, 180 nm, or the like.

For example, in these embodiments, the first electrode layer 102 is a positive electrode layer. The materials of the first electrode layer 102 include one or more of LCO, LMO, LNMO, NCA, NCM, CuS₂, TiS₂, FeS₂, SnS₂, LiFePO₄, LiMnPO₄, LiCoPO₄, LiNiPO₄, Li₃V₂(PO₄)₃, Li₂FeSiO₄, Li₂MnSiO₄, Li₂CoSiO₄, Li₂NiSiO₄, Li₂Fe₂(SO₄)₃, LiFeBO₃, LiMnBO₃, LiCoBO₃, LiNiBO₃, and V₂O₅. For example, the thickness of the first electrode layer 102 is from 200 nm to 20 μm, such as 500 nm, 1 μm, 5 μm, 10 μm, etc.

For example, in the lithium ion battery in the embodiments of the present disclosure, the electrolyte layer separates the first electrode layer and the second electrode layer, and meanwhile, enables lithium ions to move back and forth through the electrolyte layer during the charging and discharging processes of the lithium ion battery. In the solid-state lithium ion battery illustrated in FIG. 1, the electrolyte layer 103 includes a solid electrolyte layer that separates the first electrode layer 102 and the second electrode layer 104. For example, the materials of the solid electrolyte layer include, for example, one or more of LiPON, LLTO, LGSP, LPS, Thio-LiSiCON, LATP, LLZO, Li₂S, SiS₂, P₂S₅, SiS₂, and B₂S₃.

In another embodiment, the above-described solid electrolyte layer may be replaced by a polymer electrolyte layer, thereby obtaining a polymer lithium ion battery. For example, the polymer electrolyte used for the polymer electrolyte layer includes methyl methacrylate (MMA), methyl acrylate (MA), derivatives thereof, and the like; the polymer electrolyte presents a gel state, for example.

For example, in other embodiments, the electrolyte layer 103 may include a membrane as well as liquid electrolyte or polymer electrolyte. The membrane is provided between the first electrode layer 102 and the second electrode layer 104 so as to separate the two layers, and the liquid electrolyte or polymer electrolyte is immersed in the membrane, thereby obtaining a liquid lithium ion battery or a polymer lithium ion battery. For example, the liquid electrolyte includes LiPF₆ solution, LiClO₄ solution or LiAsF₆ solution, etc.

For example, in the embodiments of the present disclosure, the thickness of the electrolyte layer 103 is from 200 nm to 20 μm, such as 500 nm, 1 μm, 5 μm, 10 μm, and the like.

For example, in these embodiments, the second electrode layer 104 is a negative electrode layer. The materials of the second electrode layer 104 include one or more of tin oxide (SnO₂), graphite, lithium metal, lithium alloy and lithium compound. For example, the thickness of the second electrode layer 104 is from 200 nm to 20 μm, such as 500 nm, 1 μm, 5 μm, 10 μm, etc.

For example, in these embodiments, the second electrode current collector 105 is a negative electrode current collector layer. The materials of the second electrode current collector 107 include one or more of Mo, Cu, Ni, stainless steel, graphite and amorphous carbon. For example, the thickness of the second electrode current collector 107 is from 20 nm to 200 nm, such as 50 nm, 80 nm, 150 nm, 180 nm, etc.

It should be noted that in these embodiments, the materials of each functional layer of the lithium ion battery may be selected according to actual requirements (e.g., battery capacity, application environment of the battery, etc.) and production conditions (e.g., production cost, production equipment, etc.), and the thickness of each functional layer may be selected according to the properties of the materials of each functional layer and the demand for battery capacity, or the like. The material and the thickness of each functional layer of the lithium ion battery are not specifically limited in the embodiments.

The lithium ion battery of at least one embodiment of the present disclosure may adopt various appropriate packaging methods, for example, it may be packaged as a button battery, a columnar battery, a soft packaging battery, or the like, may be used as a household battery or a power battery, or the like, and may be removable or may be built into a product and non-removable, and the embodiments of the present disclosure are not limited thereto.

At least one embodiment of the present disclosure provides a method for preparing a lithium ion battery, which includes: forming a first electrode current collector, a first electrode layer, an electrolyte layer, a second electrode layer, and a second electrode current collector which are laminated; forming a first electron transport layer between a first electrode layer and a first electrode current collector, and/or forming a second electron transport layer between a second electrode layer and a second electrode current collector.

In at least one embodiment of the present disclosure, both the first electron transport layer and the second electron transport layer may be formed in the lithium ion battery, and only one of the first electron transport layer and the second electron transport layer may be formed, for example, only the first electron transport layer or only the second electron transport layer may be formed.

For example, in some examples of these embodiments, forming a first electron transport layer includes forming the first electron transport layer by a thin film forming method using one of the first electrode layer and the first electrode current collector as a substrate. For example, a patterned first electron transport layer is formed through a mask plate by a thin film forming method. For example, after the first electron transport layer is formed, the other of the first electrode layer and the first electrode current collector is formed, using the first electron transport layer as a substrate.

For example, in some examples of these embodiments, forming a second electron transport layer includes forming the second electron transport layer by a thin film forming method using one of the second electrode layer and the second electrode current collector as a substrate. For example, a patterned second electron transport layer is formed through a mask plate by a thin film forming method. For example, after the second electron transport layer is formed, the other of the second electrode layer and the second electrode current collector is formed using the second electron transport layer as a substrate.

For example, the method for preparing a lithium ion battery provided in the embodiments may further include: providing a substrate; forming a buffer layer on the substrate; and then forming the first electrode current collector, the first electrode layer, the electrolyte layer, the second electrode layer and the second electrode current collector which are laminated on the buffer layer. The substrate may take various appropriate forms as required, such as a flexible substrate or a rigid substrate, etc.

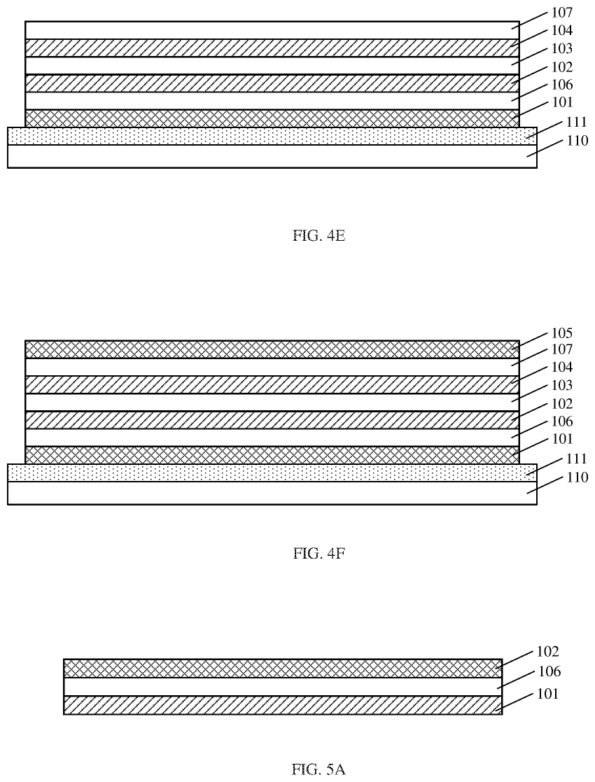

A method for preparing a solid-state lithium ion battery provided in the embodiments will be described in detail below with reference to FIGS. 4A to 4F.

As illustrated in FIG. 4A, a buffer layer 111 is first formed on a substrate 110. For example, a buffer material layer may be formed by a method such as coating, evaporating or depositing, etc. Then, the buffer material layer may also be patterned as needed. Thereby, the buffer layer 111 is formed on the substrate 110. For example, a photolithography process may be employed for patterning. For example, one photolithography process includes photoresist coating, exposure, development, etching and other working procedures.

For example, the substrate 110 may adopt a rigid substrate or a flexible substrate. For example, the rigid substrate is a rigid base plate, for which the materials may include glass, polymer (e.g., plastic), metal sheet, silicon wafer, quartz, ceramic, mica, etc. For example, the flexible substrate is a flexible film, for which the materials may include Polyimide (PI), Polyethylene Terephthalate (PET), metal film, etc. For example, the materials of the buffer layer 111 may include SiOx, SiNx or Al₂O₃, etc. The materials of the substrate 110 and the buffer layer 111 are not specifically limited in the embodiments.

As illustrated in FIG. 4B, after the buffer layer 111 is formed, a first electrode current collector 101 may be formed on the buffer layer 111. For example, if the first electrode current collector material layer is a metal film or a metal sheet, a metal film or a metal sheet of an appropriate shape can be obtained by cutting a raw material metal film or a raw material metal sheet, and then the cut metal film or the cut metal sheet is pressed or adhered to the buffer layer so as to obtain the first electrode current collector 101. For example, a patterned first electrode current collector 101 may also be directly formed on the buffer layer 111 through a mask plate by a thin film forming method such as sputtering, evaporating or depositing, etc. In this way, the pattern of the formed first electrode current collector 101 corresponds to the pattern of the mask plate.

For example, the first electrode current collector 101 is a positive electrode current collector layer. The materials of the first electrode current collector 101 include one or more of Mo, Al, Ni, stainless steel, graphite and amorphous carbon. For example, the formation thickness of the first electrode current collector 101 is from 20 nm to 200 nm, for example, 50 nm, 80 nm, 150 nm, 180 nm, etc.

For example, after the first electrode current collector 101 is formed, a first electron transport layer 106 may be formed on the first electrode current collector 101. As illustrated in FIG. 4B, in the embodiments, the first electron transport layer 106 is formed by a thin film forming method using the first electrode current collector 101 as a substrate. For example, a patterned first electron transport layer 106 is directly formed on the first electrode current collector 101 through a mask plate using a thin film forming method such as sputtering, evaporating or depositing, etc.

For example, the materials of the first electron transport layer 106 may be inorganic electron transport materials. For example, the inorganic electron transport materials include fluorides. For example, the fluorides include one or more of LiF, NaF, CsF, MgF₂, CaF₂ and BaF₂. These fluorides have good electron transport capability, can modify the interface between the adjacent current collector layer and the electrode active layer, and can have the effect of blocking ion diffusion.

For example, the formation thickness of the first electron transport layer 106 is from 1 nm to 10 nm, such as 1 nm, 3 nm, 5 nm, 7 nm, 9 nm, etc. At this thickness, the first electron transport layer 106 can substantially realize functions without affecting the overall thickness of the battery.

As illustrated in FIG. 4C, after the first electron transport layer 106 is formed, a first electrode layer 102 is formed using the first electron transport layer 106 as a substrate. For example, a patterned first electrode layer 102 may be directly formed on the first electron transport layer 106 through a mask plate using a thin film forming method such as sputtering, evaporating or depositing, etc.

For example, in these embodiments, the first electrode layer 102 is a positive electrode layer. The materials of the first electrode layer 102 include one or more of LCO, LMO, LNMO, NCA, NCM, CuS₂, TiS₂, FeS₂, SnS₂, LiFePO₄, LiMnPO₄, LiCoPO₄, LiNiPO₄, Li₃V₂(PO₄)₃, Li₂FeSiO₄, Li₂MnSiO₄, Li₂CoSiO₄, Li₂NiSiO₄, Li₂Fe₂(SO₄)₃, LiFeBO₃, LiMnBO₃, LiCoBO₃, LiNiBO₃, and V₂O₅. For example, the formation thickness of the first electrode layer 102 is from 200 nm to 20 μm, such as 500 nm, 1 μm, 5 μm, 10 μm, etc.

As illustrated in FIG. 4D, after the first electrode layer 102 is formed, an electrolyte layer 103 may be formed on the first electrode layer 102. For example, the electrolyte layer 103 formed in these embodiments includes a solid electrolyte layer or a polymer electrolyte layer. For example, the solid electrolyte layer may be formed on the first electrode layer 102 using a thin film forming method. For example, a patterned solid electrolyte layer may be directly formed on the first electrode layer 102 through a mask plate using a thin film forming method such as sputtering, evaporating or depositing, etc. For example, the polymer electrolyte layer may be formed on the first electrode layer 102 in a coating manner. For example, the materials of the solid electrolyte layer include one or more of LiPON, LLTO, LGSP, LPS, Thio-LiSiCON, LATP, LLZO, Li₂S, SiS₂, P₂S₅, SiS₂ and B₂S₃. For example, the formation thickness of the solid electrolyte layer is from 200 nm to 20 μm, for example, 500 nm, 1 μm, 5 μm, 10 μm, etc.

As illustrated in FIG. 4D, after the electrolyte layer 103 is formed, a second electrode layer 104 may be formed on the electrolyte layer 103. For example, a patterned second electrode layer 104 may be directly formed on the electrolyte layer 103 through a mask plate using a thin film forming method such as sputtering, evaporating, depositing, etc.

For example, the second electrode layer 104 is a negative electrode layer. The materials of the second electrode layer 104 include one or more of SnO₂, graphite, lithium metal, lithium alloy and lithium compound. For example, the formation thickness of the second electrode layer 104 is from 200 nm to 20 μm, such as 500 nm, 1 μm, 5 μm, 10 μm, etc.

As illustrated in FIG. 4E, after the second electrode layer 104 is formed, a second electron transport layer 107 is formed by a thin film forming method, using the second electrode layer 104 as a substrate. For example, a patterned second electron transport layer 107 is directly formed on the second electrode layer 104 through a mask plate using a thin film forming method such as sputtering, evaporating, depositing, etc.

For example, the materials of the second electron transport layer 107 may be inorganic electron transport materials, including fluorides, for example. For example, the fluorides include one or more of LiF, NaF, CsF, MgF₂, CaF₂ and BaF₂. These fluorides have good electron transport capability, can modify the interface between the adjacent current collector layer and the adjacent electrical active layer, and can have the effect of blocking ion diffusion.

For example, the formation thickness of the second electron transport layer 107 is from 1 nm to 10 nm, for example, 1 nm, 3 nm, 5 nm, 7 nm, 9 nm, etc. At this thickness, the second electron transport layer 107 can substantially realize functions without affecting the overall thickness of the battery.

As illustrated in FIG. 4F, after the second electron transport layer 107 is formed, a second electrode current collector 105 is formed using the second electron transport layer 107 as a substrate. For example, a patterned second electrode layer 104 may be directly formed on the second electron transport layer 107 through a mask plate using a thin film forming method such as sputtering, evaporating, depositing, etc. If the second electrode current collector material layer is a metal film or a metal sheet, a metal film or a metal sheet of an appropriate shape may be obtained by cutting a raw material metal film or a raw material metal sheet, and then the metal film or the metal sheet is pressed or adhered to the second electron transport layer.

For example, in these embodiments, the second electrode current collector 105 is a negative electrode current collector layer. The materials of the second electrode current collector 107 include one or more of Mo, Cu, Ni, stainless steel, graphite, and amorphous carbon. For example, the thickness of the second electrode current collector 107 is from 20 nm to 200 nm, such as 50 nm, 80 nm, 150 nm, 180 nm, etc.

It should be noted that the above embodiments are illustrated by taking as examples that the first electrode current collector 101 is a positive electrode current collector layer, the first electrode layer 102 is a positive electrode layer, the second electrode layer 104 is a negative electrode layer, and the second electrode current collector 105 is a negative electrode current collector layer. In practice, the first electrode current collector 101 may also be formed as a negative electrode current collector layer, in this case, the first electrode layer 102 is a negative electrode layer, the second electrode layer 104 is a positive electrode layer, and the second electrode current collector 105 is a positive electrode current collector layer. These embodiments do not limit the order in which the positive and negative electrodes of the battery are formed.

In another example, after the laminated structure of a buffer layer, a first electrode current collector, a first electrode layer, an electrolyte layer, a second electrode layer, a second electrode current collector, etc. is sequentially formed on a substrate, patterning, molding, or the like may be implemented by a process of cutting or the like without performing the process such as patterning in the process of forming the laminated structure. After that, the laminated structure may be further formed by winding or the like as needed, and then packaging is performed so as to obtain batteries in various forms.

In addition, in these embodiments, the formation materials of each functional layer of the lithium ion battery may be selected according to actual requirements (e.g., battery capacity, application environment of the battery, etc.) and production conditions (e.g., production cost, production equipment, etc.), and the formation thickness of each functional layer may be selected according to the properties of the selected materials of each functional layer and the demand for battery capacity, etc. The materials and formation thickness of each functional layer of the lithium ion battery are not specifically limited in these embodiments.

The lithium ion battery obtained by the method of these embodiments includes a first electron transport layer and/or a second electron transport layer. This electron transport layer can modify an interface between an electrical active layer and an electrode current collector layer which are adjacent to the electron transport layer, fill the defects possibly existing in the electrical active layer and the electrode current collector layer, and enhance the stability of the battery. Also, this electron transport layer can block ions escaping from the electrode current collector layer, such as metal ions, diffusing to the electrical active layer and then affecting the performance of the electrical active layer. In addition, this electron transport layer has good electron transport characteristics, which can improve the electron transport capability between the electrical active layer and the electrode current collector layer, thus improving the charging and discharging efficiency of the battery.

In another embodiment of the present disclosure, in the case where the electrolyte layer includes polymer electrolyte, a first electrode portion may be formed, which includes forming a first electrode current collector, a first electron transport layer, and a first electrode layer which are laminated. In addition, a second electrode portion is formed, which includes forming a second electrode current collector, a second electron transport layer, and a second electrode layer which are laminated. Then, the polymer electrolyte is formed between the first electrode portion and the second electrode portion. For example, a polymer electrolyte film is formed on the first electrode layer of the first electrode portion so as to form the electrolyte layer, and then the second electrode portion is laminated on the polymer electrolyte film, so that the second electrode layer contacts with the polymer electrolyte film.

In yet another embodiment of the present disclosure, in the case where the electrolyte layer includes a membrane and liquid electrolyte or polymer electrolyte, a first electrode portion may be formed, which includes forming a first electrode current collector, a first electron transport layer, and a first electrode layer which are laminated. In addition, a second electrode portion is formed, which includes forming a second electrode current collector, a second electron transport layer, and a second electrode layer which are laminated. Then the membrane is sandwiched between the first electrode portion and the second electrode portion, so that the membrane contacts with the first electrode layer and the second electrode layer, thereby obtaining a battery laminated structure. The battery laminated structure is wound or cut and then put into a container, and then the liquid electrolyte or the polymer electrolyte is injected into the container, and the liquid electrolyte or the polymer electrolyte is immersed into the membrane, so as to allow lithium ions to move back and forth between the first electrode portion and the second electrode portion during the processes of charging and discharging.

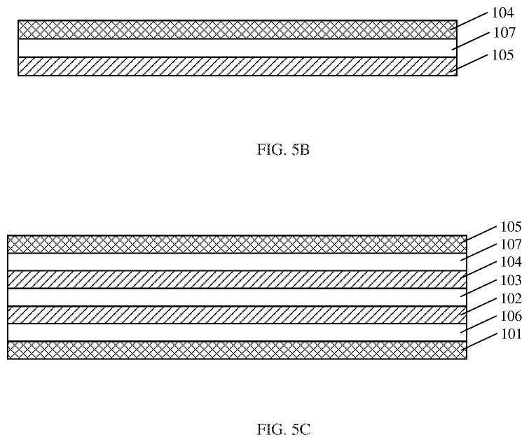

Next, a method for preparing a lithium ion battery provided in these embodiments will be described in detail with reference to FIGS. 5A to 5C.

As illustrated in FIG. 5A, first, a first electrode portion is formed, for example, a first electrode current collector 101, a first electron transport layer 106, and a first electrode layer 102 which are laminated are formed.

For example, in the case where the materials of the first electrode current collector 101 is a metal film or a metal sheet, a metal film or a metal sheet of an appropriate shape may be obtained by cutting a raw material metal film or a raw material metal sheet so as to obtain the first electrode current collector 101. For example, a patterned first electrode current collector 101 may be directly formed on a substrate (not shown) through a mask plate by a method such as sputtering, evaporating, depositing, etc.

For example, the first electrode current collector 101 is a positive electrode current collector layer. The materials of the first electrode current collector 101 include one or more of Mo, Al, Ni, stainless steel, graphite and amorphous carbon. For example, the formation thickness of the first electrode current collector 101 is from 20 nm to 200 nm, for example, 50 nm, 80 nm, 150 nm, 180 nm, etc.

For example, after the first electrode current collector 101 is formed, a first electron transport layer 106 may be formed on the first electrode current collector 101. As illustrated in FIG. 5A, a patterned first electron transport layer 106 is directly formed on the first electrode current collector 101 through a mask plate by a thin film forming method, such as sputtering, evaporating, depositing, etc., using the first electrode current collector 101 as a substrate.

For example, the materials of the first electron transport layer 106 may be inorganic electron transport materials. For example, the inorganic electron transport materials include fluorides. For example, the fluorides include one or more of LiF, NaF, CsF, MgF₂, CaF₂ and BaF₂. These fluorides have good electron transport capability, can modify an interface between an adjacent current collector layer and an adjacent electrical active layer, and can have the effect of blocking ion diffusion.

For example, the formation thickness of the first electron transport layer 106 is from 1 nm to 10 nm, for example, 1 nm, 3 nm, 5 nm, 7 nm, 9 nm, etc. At this thickness, the first electron transport layer 106 can substantially realize functions without affecting the overall thickness of the battery.

As illustrated in FIG. 5A, after the first electron transport layer 106 is formed, a first electrode layer 102 is formed using the first electron transport layer 106 as a substrate. For example, a patterned first electrode layer 102 may be directly formed on the first electron transport layer 106 through a mask plate using a method such as sputtering, evaporating, depositing, etc.

For example, in these embodiments, the first electrode layer 102 is a positive electrode layer. The materials of the first electrode layer 102 include one or more of LCO, LMO, LNMO, NCA, NCM, CuS₂, TiS₂, FeS₂, SnS₂, LiFePO₄, LiMnPO₄, LiCoPO₄, LiNiPO₄, Li₃V₂(PO4)₃, Li₂FeSiO₄, Li₂MnSiO₄, Li₂CoSiO₄, Li₂NiSiO₄, Li₂Fe₂(SO₄)₃, LiFeBO₃, LiMnBO₃, LiCoBO₃, LiNiBO₃, and V₂O₅. For example, the formation thickness of the first electrode layer 102 is from 200 nm to 20 μm, for example, 500 nm, 1 μm, 5 μm, 10 μm, etc.

As illustrated in FIG. 5B, a second electrode portion is formed, for example, a second electrode current collector 105, a second electron transport layer 107, and a first electrode layer 104 which are laminated are formed.

For example, in the case where the material of the second electrode current collector 105 is a metal film or a metal sheet, a metal film or a metal sheet of an appropriate shape may be obtained by cutting a raw material metal film or a raw material metal sheet so as to obtain the second electrode current collector 105. For example, a patterned second electrode current collector 105 may be directly formed on a substrate (not shown) through a mask plate by a method such as sputtering, evaporating, depositing, etc.

For example, in these embodiments, the second electrode current collector 105 is a negative electrode current collector layer. The materials of the second electrode current collector 105 include one or more of Mo, Cu, Ni, stainless steel, graphite, and amorphous carbon. For example, the thickness of the second electrode current collector 105 is from 20 nm to 200 nm, for example, 50 nm, 80 nm, 150 nm, 180 nm, etc.

For example, after the second electrode current collector 105 is formed, a second electron transport layer 107 may be formed on the second electrode current collector 105. As illustrated in FIG. 5B, a patterned second electron transport layer 107 is directly formed on the second electrode current collector 105 through a mask plate by a thin film forming method such as sputtering, evaporating, depositing, etc., using the second electrode current collector 105 as a substrate.

For example, the materials of the second electron transport layer 107 may be inorganic electron transport materials. For example, the inorganic electron transport materials include fluorides. For example, the fluorides include one or more of LiF, NaF, CsF, MgF₂, CaF₂ and BaF₂. These fluorides all have good electron transport capability, can modify an interface between an adjacent current collector layer and an adjacent electrical active layer, and can have the effect of blocking ion diffusion.

For example, the formation thickness of the second electron transport layer 107 is from 1 nm to 10 nm, such as 1 nm, 3 nm, 5 nm, 7 nm, 9 nm, etc. At this thickness, the second electron transport layer 107 can substantially realize functions without affecting the overall thickness of the battery.

As illustrated in FIG. 5B, after the second electron transport layer 107 is formed, a second electrode layer 104 is formed using the second electron transport layer 107 as a substrate. For example, a patterned second electrode layer 104 may be directly formed on the second electron transport layer 107 through a mask plate by a method such as sputtering, evaporating, depositing, etc.

For example, the second electrode layer 104 is a negative electrode layer. The materials of the second electrode layer 104 include one or more of SnO₂, graphite, lithium metal, lithium alloy and lithium compound. For example, the formation thickness of the second electrode layer 104 is from 200 nm to 20 μm, such as 500 nm, 1 μm, 5 μm, 10 μm, etc.

As illustrated in FIG. 5C, after the first electrode portion and the second electrode portion are formed, an electrolyte layer 103 is formed between the first and second electrode portions. For example, in an example, the electrolyte layer 103 includes a polymer electrolyte film. For example, the polymer electrolyte film is formed on the first electrode portion, and then the second electrode portion is provided opposite to the first electrode portion. For example, in another example, the electrolyte layer 103 includes a membrane and polymer electrolyte or liquid electrolyte. For example, the membrane is formed between the first electrode portion and the second electrode portion. For example, a membrane prepared in advance is sandwiched between the first electrode portion and the second electrode portion, and the liquid electrolyte or polymer electrolyte is injected into the laminated structure in the subsequent processes, so that the liquid electrolyte or polymer electrolyte is immersed in the membrane. For example, the membrane may be a woven membrane, nonwoven fabric, microporous membrane, composite membrane, etc., for example, polyolefin microporous membrane using polypropylene, polyethylene, etc.

For example, the liquid electrolyte includes LiPF₆ solution, LiClO₄ solution, LiAsF₆ solution, etc. The polymer electrolyte includes, for example, methyl methacrylate (MMA), methyl acrylate (MA), derivatives thereof, and the like. For example, the formation thickness of the electrolyte layer 103 is from 200 nm to 20 μm, such as 500 nm, 1 μm, 5 μm, 10 μm, etc. The materials and the forming methods of the electrolyte layer 103 are not specifically limited in the embodiments.

In addition, in these embodiments, the formation materials of each functional layer of the lithium ion battery may be selected according to actual requirements (e.g., battery capacity, application environment of the battery, etc.) and production conditions (e.g., production cost, production equipment, etc.), and the formation thickness of each functional layer may be selected according to the properties of the selected materials of each functional layer and the demand for battery capacity, or the like. The materials and formation thickness of each functional layer of the lithium ion battery are not specifically limited in the embodiments.

The lithium ion battery obtained by the method of these embodiments includes a first electron transport layer and/or a second electron transport layer. This electron transport layer can modify an interface between an electrical active layer and an electrode current collector layer which are adjacent to the electron transport layer, fill the defects possibly existing in the electrical active layer and the electrode current collector layer, and enhance the stability of the battery. Also, this electron transport layer can block ions escaping from the electrode current collector layer, such as metal ions, diffusing to the electrical active layer and then affecting the performance of the electrical active layer. In addition, this electron transport layer has good electron transport characteristics, which can improve the electron transport capability between the electrical active layer and the electrode current collector layer, thus improving the charging and discharging efficiency of the battery.

For the present disclosure, the following statements should be noted:

(1) The accompanying drawings of the present disclosure involve only the structure(s) in connection with the embodiment(s) of the present disclosure, and for other structure(s), reference can be referred made to common design(s).

(2) For clarity, in the accompanying drawings used to describe the embodiment(s) of the present disclosure, the thickness of layers or regions is enlarged or reduced, i.e., the drawings are not drawn to actual scale. It should be understood, in the case where an element such as a layer, film, region, substrate or the like is referred to as being “on” or “under” another element, the element may be “directly” “on” or “under” another element or an intervening element may be existed.

(3) The embodiments of the present disclosure and features in the embodiments may be combined with each other to obtain new embodiments if they do not conflict with each other.

The above descriptions are only specific implementations of the present disclosure, but the scope of the present disclosure is not limited to this. Any skilled person familiar with the technical field can easily think of changes or substitutions within the technical scope disclosed in the present disclosure, which should be covered within the scope the present disclosure. Therefore, the scope of the present disclosure is defined by the accompanying claims.

1. A lithium ion battery comprising:
a first electrode current collector, a first electrode layer, an electrolyte layer, a second electrode layer, and a second electrode current collector which are laminated; and
a first electron transport layer and/or a second electron transport layer, wherein the first electron transport layer is provided between the first electrode layer and the first electrode current collector, and the second electron transport layer is provided between the second electrode layer and the second electrode current collector.

2. The lithium ion battery according to claim 1, wherein materials of the first electron transport layer and/or the second electron transport layer are inorganic electron transport materials.

3. The lithium ion battery according to claim 2, wherein the inorganic electron transport materials comprise fluorides.

4. The lithium ion battery according to claim 3, wherein the fluorides comprise one or more of LiF, NaF, CsF, MgF₂, CaF₂ and BaF₂.

5. The lithium ion battery according to claim 1, wherein a thickness of the first electron transport layer and/or a thickness of the second electron transport layer is from 1 nm to 10 nm.

6. The lithium ion battery according to claim 1, further comprising:
a substrate; and
a buffer layer, provided on the substrate,
wherein the first electrode current collector, the first electrode layer, the electrolyte layer, the second electrode layer, and the second electrode current collector which are laminated are provided on the buffer layer.

7. The lithium ion battery according to claim 1, wherein the first electrode layer is a positive electrode layer, comprising one or more of LCO, LMO, LNMO, NCA, NCM, CuS₂, TiS₂, FeS₂, SnS₂, LiFePO₄, LiMnPO₄, LiCoPO₄, LiNiPO₄, Li₃V₂(PO₄)₃, Li₂FeSiO₄, Li₂MnSiO₄, Li₂CoSiO₄, Li₂NiSiO₄, Li₂Fe₂(SO₄)₃, LiFeBO₃, LiMnBO₃, LiCoBO₃, LiNiBO₃, and V₂O₅.

8. The lithium ion battery according to claim 1, wherein materials of the first electrode current collector comprise one or more of Mo, Al, Ni, stainless steel, graphite and amorphous carbon.

9. The lithium ion battery according to claim 1, wherein the electrolyte layer comprises a solid electrolyte layer or a polymer electrolyte layer, which separates the first electrode layer and the second electrode layer.

10. The lithium ion battery according to claim 9, wherein materials of a solid electrolyte layer comprise one or more of LiPON, LLTO, LGSP, LPS, Thio-LiSiCON, LATP, LLZO, Li₂S, SiS₂, P₂S₅, and B₂S₃.

11. The lithium ion battery according to claim 1, wherein the electrolyte layer comprises a membrane and liquid electrolyte or polymer electrolyte, the membrane is provided between the first electrode layer and the second electrode layer, and the liquid electrolyte or the polymer electrolyte is immersed in the membrane.

12. The lithium ion battery according to claim 1, wherein the second electrode layer is a negative electrode layer, comprising one or more of SnO₂, graphite, lithium metal, lithium alloy and lithium compound.

13. The lithium ion battery according to claim 1, wherein materials of the second electrode current collector comprise one or more of Mo, Cu, Ni, stainless steel, graphite and amorphous carbon.

14. A method for preparing a lithium ion battery, comprising:
forming a first electrode current collector, a first electrode layer, an electrolyte layer, a second electrode layer, and a second electrode current collector which are laminated; and
forming a first electron transport layer between a first electrode layer and a first electrode current collector, and/or forming a second electron transport layer between a second electrode layer and a second electrode current collector.

15. The lithium ion battery according to claim 2, further comprising:
a substrate; and
a buffer layer, provided on the substrate,
wherein the first electrode current collector, the first electrode layer, the electrolyte layer, the second electrode layer, and the second electrode current collector which are laminated are provided on the buffer layer.

16. The lithium ion battery according to claim 2, wherein the electrolyte layer comprises a solid electrolyte layer or a polymer electrolyte layer, which separates the first electrode layer and the second electrode layer.

17. The lithium ion battery according to claim 2, wherein the electrolyte layer comprises a membrane and liquid electrolyte or polymer electrolyte, the membrane is provided between the first electrode layer and the second electrode layer, and the liquid electrolyte or the polymer electrolyte is immersed in the membrane.
